(19) United States
(12) Patent Application Publication
(10) Pub. No.: US 2014/0001966 A1
(43) Pub. Date: Jan. 2, 2014

(54) DISPLAY PANEL FOR PREVENTING STATIC ELECTRICITY, METHOD FOR MANUFACTURING THE SAME, AND DISPLAY DEVICE INCLUDING THE DISPLAY PANEL FOR PREVENTING STATIC ELECTRICITY

(71) Applicant: SAMSUNG DISPLAY CO., LTD., Yongin-si (KR)

(72) Inventor: YEON-JE CHO, Yongin-si (KR)

(73) Assignee: SAMSUNG DISPLAY CO., LTD., Yongin-si (KR)

(21) Appl. No.: 13/714,275

(22) Filed: Dec. 13, 2012

(30) Foreign Application Priority Data
Jul. 2, 2012 (KR) 10-2012-0071792

(51) Int. Cl. H05B 37/00; H05B 33/10

(52) U.S. Cl. CPC H05B 37/00; H05B 33/10
USPC 315/161; 445/3

(57) ABSTRACT

A display panel, a manufacturing method of the display panel, and a display device including the display panel are provided. The display panel includes: a substrate; a display unit on the substrate and including a plurality of pixels for displaying an image according to a video signal; a power supply wire on the substrate, coupled to the plurality of pixels, and configured to transmit a driving voltage for driving the plurality of pixels; and a dummy wire on the substrate, separated from the display unit and the power supply wire, and coupled to a ground electrode or a power supply unit for supplying the driving voltage.

### CROSS-REFERENCE TO RELATED APPLICATION

This application claims priority to and the benefit of Korean Patent Application No. 10-2012-0071792, filed in the Korean Intellectual Property Office on Jul. 2, 2012, the entire content of which is incorporated herein by reference.

### BACKGROUND

(a) Field

Aspects of embodiments of the present invention relate to a static electricity preventing display panel, a manufacturing method of the static electricity preventing display panel, and a display device including the static electricity preventing display panel.

(b) Description of the Related Art

Flat panel displays such as organic light emitting diode (OLED) displays have an application range that has been rapidly increasing due to their low weight, thinness, low power consumption, good color representation, and high resolution. Currently, usage of the OLED displays is increasing in computers, laptops, phones, TVs, and audio/video devices. The OLED display controls a driving current amount transmitted to an organic light emitting element according to an image data signal or video signal applied to a plurality of pixels arranged in a matrix shape to display an image according to data signals.

Glass substrates may be used as substrates of the display panels. However, these glass substrates act as insulators such that static electricity generated in a panel manufacturing process is charged to the glass substrates. This results in dust, etc., being easily attached thereto, thereby generating process defects. Further, the static electricity may damage elements inside the panel.

The above information disclosed in this Background section is only for enhancement of understanding of the background of the present invention and therefore, it may contain information that does not form the prior art that is already known in this country to a person of ordinary skill in the art.

### SUMMARY

Aspects of embodiments of the present invention are directed toward a static electricity preventing display panel, a manufacturing method of the static electricity preventing display panel, and a display device including the static electricity preventing display panel. Further aspects relate to a static electricity preventing display panel using a wire to test a mother glass of display panels, a manufacturing method of the static electricity preventing display panel, and a display device including the static electricity preventing display panel.

An exemplary embodiment of the present invention helps prevent erroneous operation of, and damage to, a display panel, and helps prevent a process deterioration of a corresponding display device (incorporating the display panel) due to static electricity by helping to prevent inflow and generation of static electricity in the display panel. In addition, an exemplary embodiment of the present invention provides for a display panel having excellent efficiency in eliminating static electricity in the corresponding display device (incorporating the display panel) by helping prevent static electricity from flowing in through an outermost wire of the display panel remaining after testing a mother glass of the display panels.

In an exemplary embodiment of the present invention, a display panel is provided. The display panel includes: a substrate; a display unit on the substrate and including a plurality of pixels for displaying an image according to a video signal; a power supply wire on the substrate, coupled to the plurality of pixels, and configured to transmit a driving voltage for driving the plurality of pixels; and a dummy wire on the substrate, separated from the display unit and the power supply wire, and coupled to a ground electrode or a power supply unit for supplying the driving voltage.

The dummy wire may be a wire for testing a mother glass including a plurality of display panels including the display panel.

The dummy wire may be coupled to a capacitor that is coupled to the ground electrode or the power supply unit. The capacitor may include one terminal coupled to the dummy wire and another terminal coupled to the ground electrode or the power supply unit.

The dummy wire may be extended to a flexible printed circuit (FPC) including the ground electrode or the power supply.

The substrate may be a flexible substrate. The dummy wire may be extended to the FPC after passing through a film on which is mounted a driver for driving the display unit.

The power supply wire may include a first power supply wire for transmitting a first power source voltage, and a second power supply wire for transmitting a second power source voltage that is lower than the first power source voltage.

The power supply unit may include a first power source voltage supply unit for supplying a first power source voltage of a high potential, and a second power source voltage supply unit for supplying a second power source voltage of a low potential that is lower than the first power source voltage. The dummy wire may be coupled to the second power source voltage supply unit of the power supply unit.

The dummy wire may be located at edges of the substrate.

The dummy wire may be configured to transmit and remove static electricity through the ground electrode or the power supply unit coupled to the dummy wire.

According to another exemplary embodiment of the present invention, a method of manufacturing a display panel is provided. The method includes: manufacturing a mother glass including the display panel and a dummy wire for testing the mother glass; testing the mother glass for defects using the dummy wire; cutting the mother glass into a plurality of display panels including the display panel; coupling a driving circuit for driving a plurality of pixels included in the display panel, the display panel being configured to display an image according to a video signal; grounding the dummy wire included in the display panel or coupling the dummy wire to a power source voltage supply unit for supplying a power source voltage of a low potential; and testing the display panel for defects after the grounding of the dummy wire or the coupling of the dummy wire to the power source voltage supply unit.

The dummy wire may be electrically floated after the cutting of the mother glass.

The power source voltage of the low potential may be a lower voltage than a voltage of static electricity flowing in to the dummy wire.

The dummy wire may be coupled to a capacitor that is coupled to a ground electrode or the power source voltage supply unit.

According to yet another exemplary embodiment of the present invention, a display device is provided. The display device includes: a substrate; a display unit on the substrate and including a plurality of pixels for displaying an image according to a video signal; a power supply wire on the substrate, coupled to the plurality of pixels, and configured to transmit a driving voltage for driving the plurality of pixels; a dummy wire on the substrate, separated from the display unit and the power supply wire, and coupled to a ground electrode or a power supply unit for supplying the driving voltage; and a flexible printed circuit (FPC) including the ground electrode or the power supply unit.

The substrate may be a flexible substrate. The display device may further include a film between the substrate and the FPC on which is mounted a driving circuit for controlling operation of the display unit.

The FPC may further include a bypass capacitor for storing static electricity flowing in to the dummy wire. The bypass capacitor may include one terminal coupled to the dummy wire and another terminal coupled to the ground electrode or the power supply unit.

The power supply wire may include a first power supply wire for transmitting a first power source voltage, and a second power supply wire for transmitting a second power source voltage that is lower than the first power source voltage. The dummy wire may be coupled to the second power supply wire.

The power supply unit may include a second power source voltage supply unit for supplying the second power source voltage to the second power supply wire. The dummy wire may be coupled to the second power source voltage supply unit.

The dummy wire may be a wire for testing a mother glass of a plurality of ones of the display unit, the power supply wire, and the dummy wire.

The dummy wire may be located at edges of the substrate.

According to the above and other embodiments of the present invention, inflow and generation of static electricity to a display panel may be prevented such that erroneous operation of, and damage to, the display panel, and a process defect of a corresponding display device (incorporating the display panel) due to static electricity may be prevented. In addition, static electricity flowing in due to an outermost wire of the display panel remaining after the mother glass test of the display panels may be prevented such that static electricity may be efficiency reduced or eliminated in the display device, and display panels having excellent quality may be provided.

### BRIEF DESCRIPTION OF THE DRAWINGS

FIG. 1 to FIG. 4 are views of display devices including a static electricity preventing display panel according to various exemplary embodiments of the present invention.

FIG. 5 is a top view of a layout structure of a display panel according to an exemplary embodiment of the present invention.

FIG. 6 is a partial enlarged cross-sectional view of a portion A of FIG. 5.

FIG. 7 is a flowchart of a manufacturing method of a static electricity preventing display panel according to an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Parts not related to the present invention may be omitted for clearer description. Further, like reference numerals designate like elements and similar constituent elements throughout the specification and drawings. Throughout this specification and the claims that follow, when it is described that an element is “coupled” to another element, the element may be “directly coupled” (e.g., connected) to the other element or “indirectly coupled” (e.g., electrically connected) to the other element through one or more third elements. In addition, unless explicitly described to the contrary, the word “comprise” and variations such as “comprises” or “comprising” will be understood to imply the inclusion of stated elements but not the exclusion of any other elements.

According to comparative methods of manufacturing display panels, when a mother glass of the display panels is cut after testing the mother glass in the manufacturing process of the display panels, outermost wires for testing the display panels of the mother glass may remain on right and left edges of the panels. As such, outermost wires for testing the display panels of the mother glass may be floated (e.g., electrically floated) after the cutting such that an inflow path of static electricity may be formed close to a power supply wire or a signal wire, which can lead to process defects and damage to elements in the display panels. Accordingly, exemplary embodiments of the present invention provide for the manufacture of display panels that help to prevent erroneous operation and damage to the display panels of OLED displays due to static electricity and, more particularly, that help to help prevent static electricity from flowing in through outer wires used for testing a mother glass of such display panels.

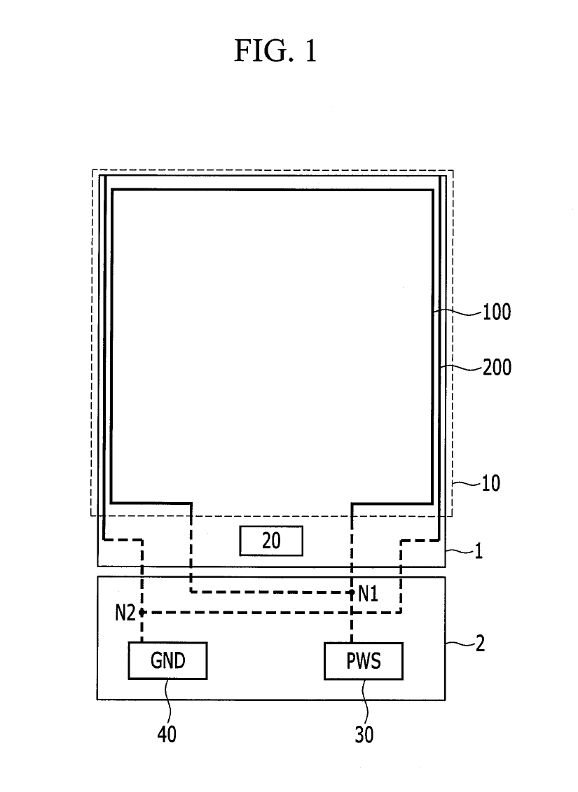

FIG. 1 to FIG. 4 are views of display devices including a static electricity preventing display panel 1 according to various exemplary embodiments of the present invention.

The illustrated display devices of the display panel 1 of FIG. 1 to FIG. 4 mainly reflect characteristics of embodiments of the present invention. Accordingly, for better understanding and ease of description, characteristics of general display panels that are commonly known to those of ordinary skill in the art may be omitted in the display panel devices of FIG. 1 to FIG. 4.

Referring to FIG. 1, the display panel 1 is coupled to a particular circuit (for example, a predetermined circuit) mounted to a flexible printed circuit (FPC) or a printed circuit board (PCB) 2. The display panel 1 includes a display unit 10 for displaying an image by using a plurality of pixels, and a driver 20 for operating the plurality of pixels. The display unit 10 includes, for example, a glass substrate as a base substrate, and an upper opposing substrate facing the glass substrate. The display unit further includes the plurality of pixels (for displaying the image) between the glass substrate and the opposing substrate. In some embodiments, the glass substrate of the display panel 1 may be extended from the display unit 10 to include the driver 20 thereon.

A second power supply wire 100 and a dummy wire 200 are formed on the glass substrate of the display panel 1. Integrated circuits (for example a gate driver, a data driver, etc.) for providing driving signals to the display panel 1 may be, for example, provided in the driver 20 or mounted on the FPC 2, thereby transmitting the driving signals to the display panel through the driver 20 or the FPC 2. The kind of FPC or PCB 2 of the present invention is not limited to the above. In other embodiments, it may be, for example, a rigid PCB or a flexible PCB.

Referring to the exemplary embodiment of FIG. 1, for convenience of description, it will be assumed that the integrated circuits are included in the driver 20, which is in turn provided on the glass substrate of the display panel 1, while a power supply unit (PWS) 30 for supplying a power source voltage for driving the display panel 1, and a ground electrode (GND) 40 for transmitting a ground voltage are formed on the FPC 2. In addition, the second power supply wire 100 is for supplying a second power source voltage of a low level from among a first power source voltage and the second power source voltage supplied from the power supply unit 30 to drive the display panel 1.

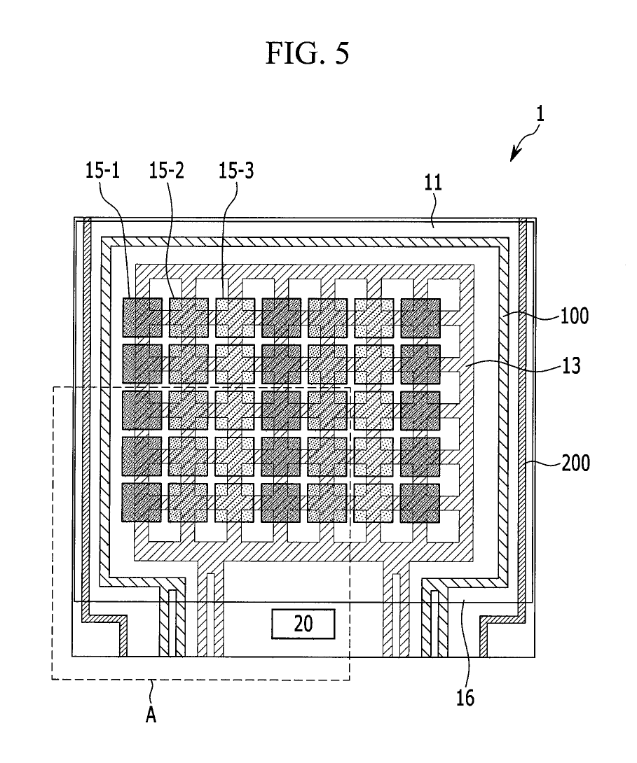

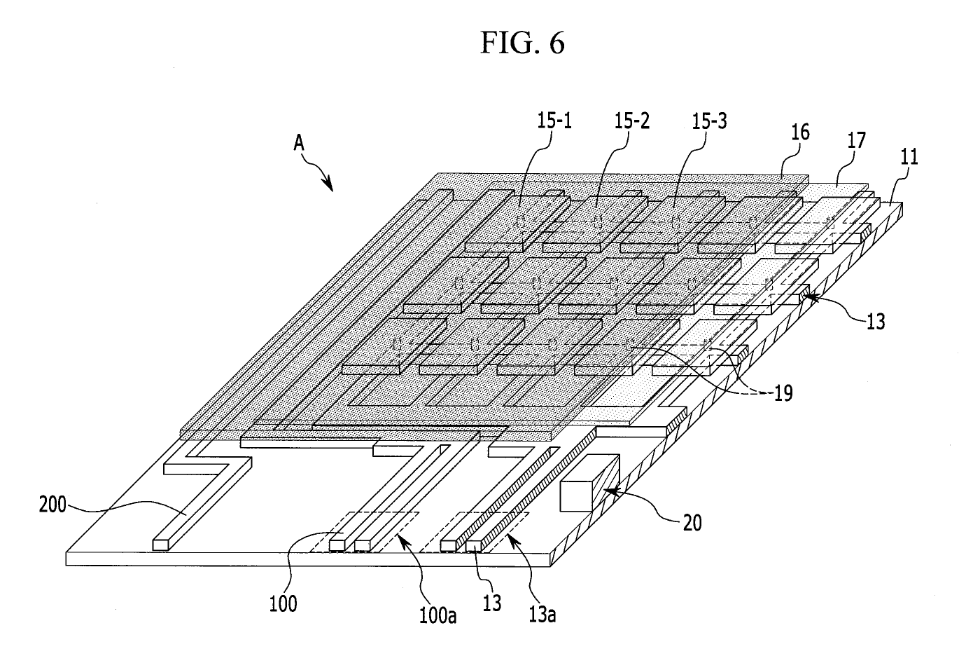

The second power supply wire 100 is formed on the glass substrate to enclose an edge portion of the display panel 1. Also, the second power supply wire 100 is coupled to a first common node N1, and a wire extended from the first common node N1 is coupled to the power supply unit 30 formed on the FPC 2. The power supply unit 30 supplies the second power source voltage (ELVSS) of a low level through the second power supply wire 100. The power supply unit 30 supplies the first power source voltage (ELVDD) of a high level through a first power supply wire (see, for example, first power supply wire 13 of FIG. 5 and FIG. 6).

Meanwhile, the dummy wire 200 formed on the glass substrate in FIG. 1 is provided on the right and left edge portions of the display panel 1. In other embodiments, the dummy wire may be provided on other portions of the display panel, for example, on other edge portions. The dummy wire 200 in FIG. 1 represents outermost wires for a mother glass test of the display panels, and are floated after a cell cutting step of a panel (cell) process is performed after the mother glass test.

This outermost dummy wire 200 that is provided for an external test (for example, while the display panel 1 is on a mother glass of display panels) may also form a main inflow path of static electricity to the display panel. As such, it is desirable to form a structural and circuit member for preventing generation of static electricity due to the dummy wire 200 in the manufacturing process of the display panel 1 of the display device. Accordingly, referring to FIG. 1, the dummy wire 200 that is floating (e.g., electrically floating) after the cell cutting of the panel (cell) process is then coupled to the ground electrode 40 of the FPC 2. For example, in FIG. 1, the dummy wire 200 is coupled to a second common node N2, and the second common node N2 is in turn coupled to the ground electrode 40. Thus, static electricity current flowing in through the dummy wire 200 from the outside flows through the ground electrode 40 such that static electricity generation and accumulation within the display panel may be prevented.

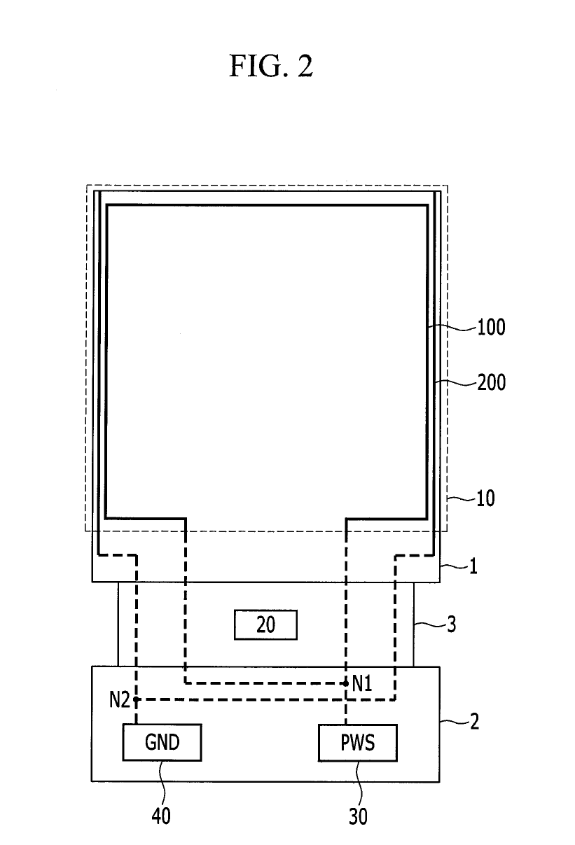

FIG. 2 is a view of a display device including a display panel 1 for preventing static electricity according to another exemplary embodiment of the present invention.

For the exemplary embodiment of FIG. 2, the display panel 1 is a flexible display panel (e.g., is formed on a flexible substrate). In addition, the display device further includes a chip on film (COF) 3, and the driver 20 is formed on the chip on film 3. The display panel 1 of FIG. 2 is coupled to the circuits of the FPC 2 through the chip on film 3. The second power supply wire 100 provided in the display panel 1 is extended through the chip on film 3 to be coupled to the power supply unit 30 mounted on the FPC 2, thereby receiving the second power source voltage (ELVSS) of the low level.

Meanwhile, the mother glass test dummy wire 200 that is formed at the right and left outermost edge portions of the display panel 1 is extended through the chip on film 3 to be coupled to the second common node N2, which is in turn coupled to the ground electrode 40 formed in the FPC 2. The display device of FIG. 2 is not largely different from the display device of FIG. 1 except for the driver 20 being provided on, and the wires being extended through, the chip on film 3. In FIG. 2, static electricity flowing in through the dummy wire 200 is discharged through the ground electrode 40 such that the display panel 1 is protected from the static electricity.

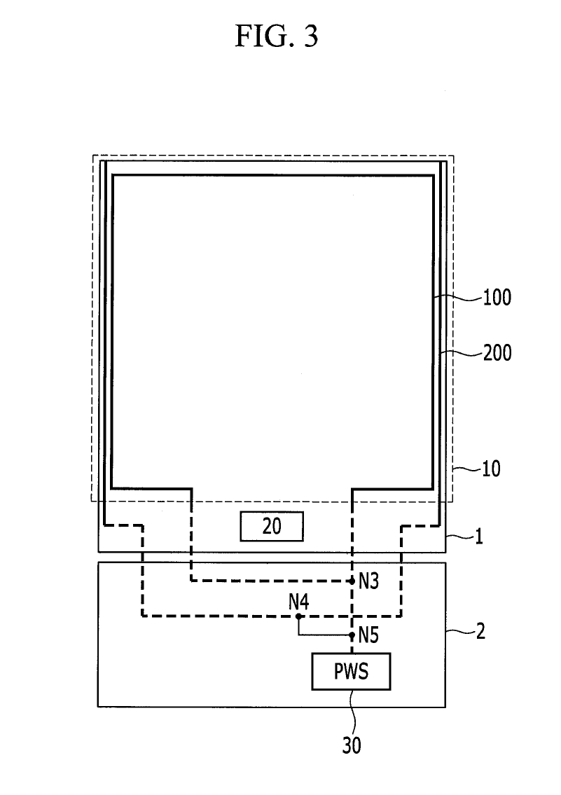

FIG. 3 is a view of a display device including a display panel 1 for preventing static electricity according to another exemplary embodiment of the present invention.

The display device of FIG. 3 is not largely different from the exemplary embodiment of FIG. 1, however the second power supply wire 100 and the mother glass test dummy wire 200 extended from the display panel 1 are both coupled to the power supply unit 30 in the display device of FIG. 3. That is, the second power supply wire 100 of the display panel 1 is coupled to a third common node N3 and the outermost dummy wire 200 is coupled to a fourth common node N4, and the third common node N3 and the fourth common node N4 are in turn coupled to a fifth common node N5, which is in turn coupled to the power supply unit 30 of the FPC 2. That is, the FPC 2 of FIG. 3 does not provide the ground electrode connection to the dummy wire 200.

The dummy wire 200 is coupled to a member (for example, a wire or an electrode) for supplying the second power source voltage (ELVSS) of the low level from the power supply unit 30. Although the second power supply wire 100 and the dummy wire 200 are coupled, thereby receiving the second power source voltage of the low level, static electricity transmitted through the dummy wire 200 may be removed by the second power source voltage of the low potential.

For the display device of FIG. 3, after the mother glass test is performed with the dummy wire 200, when the FPC 2 and the display panel 1 are coupled in the module manufacturing process, the second power supply wire 100 may be coupled to the fifth common node N5. When the display panel 1 of FIG. 3 is a flexible display panel, the display panel 1 of FIG. 3 may be coupled to the circuits of the FPC 2 through a chip on film 3 as in the display device of FIG. 2.

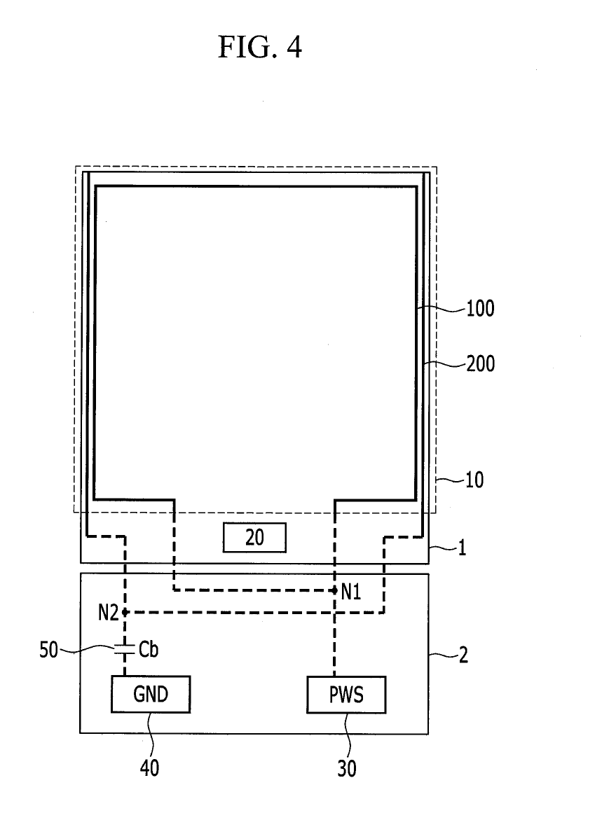

FIG. 4 is a view of a display device including a display panel 1 for preventing static electricity according to another exemplary embodiment of the present invention. The display device of FIG. 4 is similar to the exemplary embodiment of FIG. 1. However, the outermost dummy wire 200 of the display panel 1 in FIG. 4 is coupled to a bypass capacitor (Cb) 50 of the FPC 2.

That is, the dummy wire 200 of the display panel 1 is coupled to the second common node N2, which is in turn coupled to one terminal of the bypass capacitor 50 formed on the FPC 2. In addition, the other terminal of the bypass capacitor 50 is coupled to the ground electrode 40 formed in the same FPC 2. The bypass capacitor 50 bypasses static electricity that may flow in through the dummy wire 200 from the outside to be temporary stored. Further, in the exemplary embodiment of FIG. 4, when the display panel 1 is a flexible display panel, as in the display device of FIG. 2, the display panel 1 of FIG. 4 may be coupled to the circuit of the FPC 2 through the chip on film 3.

FIG. 5 is a top view of a layout structure of a display panel 1 according to an exemplary embodiment of the present invention.

For better understanding and ease of description, constituent elements of the display panel 1 may be partially omitted (for example, fewer rows and columns may be depicted in FIG. 5). It is understood, however, that these constituent elements may be further added to the display panel 1 in FIG. 5 without departing from the spirit and scope of the present invention as would be apparent to one of ordinary skill in the art.

Referring to FIG. 5, firstly, a glass substrate 11 is provided as a base substrate. According to an exemplary embodiment, a driver 20 may be mounted on the glass substrate in a region other than a region where a display unit is formed. The constituent elements corresponding to the display unit may be sequentially mounted on the glass substrate 11 on the region where the display unit is formed. At this point, a first power supply wire 13, the second power supply wire 100, and the dummy wire 200 are formed.

As described in the above exemplary embodiment, the second power supply wire 100 is positioned in the edge portion of the display panel 1 while the display unit including a plurality of pixels is positioned in the center portion of the display panel 1. In addition, the dummy wire 200 is positioned along the right and left edge portions of the display panel 1. The dummy wire 200 used in the mother glass test remains in a floating state after the cell cutting process (which takes place after the mother glass test), as shown in FIG. 5.

The first power supply wire 13 is a wire for receiving and transmitting the first power source voltage (ELVDD) of the high potential from the power supply unit 30, and may be formed with a lattice shape in the region of the display unit. The first power supply wire 13 in FIG. 5 is extended in a vertical direction and in a horizontal direction to form a matrix structure on the glass substrate 11. After the first power supply wire 13 is formed, the pixels respectively corresponding to the crossing regions of the first power supply wire 13 in the vertical direction and the horizontal direction are formed. The arrangement shape of the first power supply wire and the pixels are not limited to the exemplary embodiment of FIG. 5. For example, in other embodiments, the first power supply wire may only contact the pixels included in the display unit in the vertical direction (e.g., if the first supply wire only extends in the vertical direction in the display unit) to supply the first power source voltage.

The display unit includes subpixels for displaying one of three colors (for example, red, green, and blue) as shown in FIG. 5. The display unit includes a plurality of red subpixels 15-1, a plurality of green subpixels 15-2, and a plurality of blue subpixels 15-3 that are repeatedly arranged on the first power supply wire 13. As described above, the subpixels may be formed at each crossing region of a vertical direction wire and a horizontal direction wire of the first power supply wire 13. However, the arrangement of the subpixels is not limited to that shown in FIG. 5, and may differ in other embodiments.

After forming the display unit in FIG. 5, a layer for supplying the second power source voltage (ELVSS) as a plate electrode may be formed on the entire region of the display unit. This supplying layer of the second power source voltage is coupled to the second power supply wire 100. An opposing substrate 16 is then formed on the supplying layer for the second power source voltage. The opposing substrate 16 is an upper substrate facing the glass substrate 11 of the base substrate and may be formed of a transparent material such as glass.

FIG. 6 is a partial enlarged cross-sectional view of a portion A of FIG. 5 to help explain the structure of the display panel 1 of FIG. 5 in further detail.

Referring to FIG. 6, the glass substrate 11 as the base substrate is formed at a lowest portion. The driver 20 is formed outside of the region for forming the display unit. The first power supply wire 13, the second power supply wire 100, and the dummy wire 200 are formed on the glass substrate 11. A connection 13a (for example, a pad) of the first power supply wire 13 and a connection 100a (for example, a pad) of the second power supply wire 100 are extended to the FPC to thereby respectively receive the first power source voltage (ELVDD) and the second power source voltage (ELVSS) from the power supply unit 30.

The plurality of pixels is formed at the crossing regions of the vertical wires and the horizontal wires of the first power supply wire 13 arranged with the lattice shape. For example, the plurality of pixels is arranged as subpixels of the different colors, such as one of the first color subpixels 15-1 (arranged in a row (or column) direction) for displaying a first color, one of the second color subpixels 15-2 (arranged in a row (or column) direction) for displaying a second color, and one of the third color subpixels 15-3 (arranged in a row (or column) direction) for displaying a third color, which are sequentially and repeatedly arranged. Here, the first color may be red, the second color may be green, and the third color may be blue. The pixel arrangement of the colors is not limited thereto, and may differ in other embodiments.

After forming the subpixels, a second power source voltage layer 17 for supplying the second power source voltage is formed on a region corresponding to the display unit and coupled to the second power supply wire 100. The first power source voltage and the second power source voltage for driving the display unit is supplied from the power supply unit (for example, power supply unit 30 in FIG. 1 to FIG. 4). Accordingly, the first power source voltage (ELVDD) of the high potential and the second power source voltage (ELVSS) of the low potential or the ground potential may be respectively supplied.

The first power supply wire 13 transmits the first power source voltage (ELVDD) of the high potential to the pixels, while the second power source wire 100, which is coupled to the second power source voltage supply layer 17, transmits the second power source voltage (ELVSS) of the low potential or the ground potential to the pixels. The display panel 1 includes contact holes 19 to couple each of the plurality of subpixels 15-1, 15-2, and 15-3 of the display unit to the first power supply wire 13. In addition, the display panel 1 includes a connection coupling each of the plurality of subpixels 15-1, 15-2, and 15-3 to the second power source voltage supply layer 17.

Finally, an opposing substrate 16 is formed at an uppermost portion of the display unit region. The opposing substrate 16 may be a glass substrate or other substrate made of a transparent material. In the display panel of FIG. 6, to prevent static electricity flowing in from the outside through the remaining dummy wire 200 in the floated state on the glass substrate 11 after the cell cutting process (which takes place after the mother glass test), the end of the dummy wire 200 is coupled to the ground electrode or the power supply unit for supplying the second power source voltage (ELVSS).

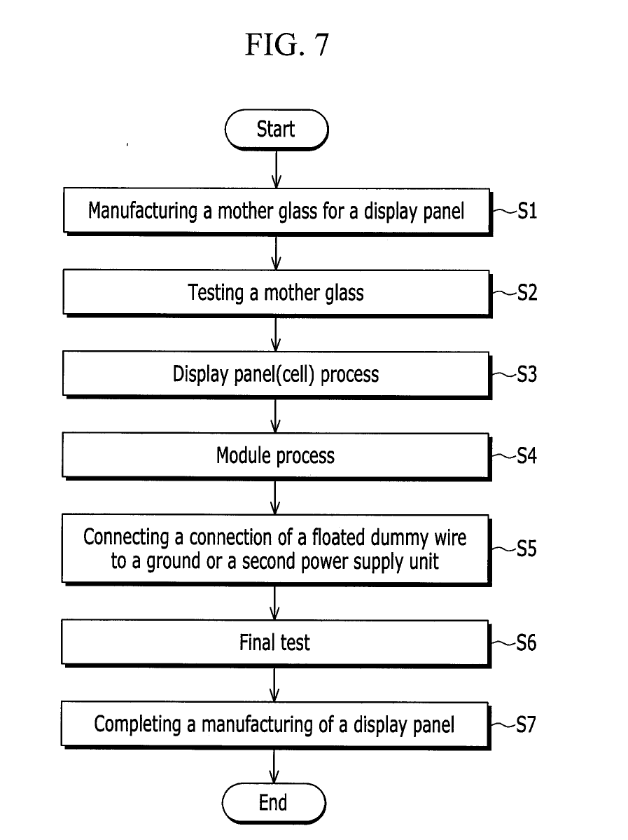

FIG. 7 is a flowchart of a manufacturing method of a static electricity preventing display panel according to an exemplary embodiment of the present invention.

The display panel 1 according to embodiments of the present invention has a structure that removes static electricity by using a dummy wire. In FIG. 7, a process of manufacturing a mother glass of the display panels is first performed (S1). The mother glass for the display panels may be manufactured by forming a plurality of display panels including a plurality of display units and a sealing member between the lower base substrate (the glass substrate) and the opposing substrate facing thereto. For testing the quality and/or performance of the mother glass when manufacturing the mother glass, a dummy wire to transmit a current is formed. The arrangement and the number of the dummy wires are not limited. For example, the dummy wires may be located at the right and left sides for each cell (that is, a unit corresponding to a display panel).

Next, a process of testing the mother glass for defects is performed (S2). In the mother glass test, the mother glass is coupled through the dummy wire to test the quality and/or performance of the mother glass. If the mother glass is defective, it is repaired through a repairing process if possible, or the mother glass is disposed of as a faulty product if the repairing is impossible. The tested mother glass that is repaired (if needed) and that is determined to be a good product then undergoes a display panel (cell) process (S3). The panel (cell) process includes a process of finishing OLEDs (such as completely forming or further forming the OLEDs), and a cell cutting process of cutting the mother glass into units in which the dummy wire is floated. In the display panel process, the panel test process may be performed as a cell unit.

Next, a module process (S4) is performed. The module process is a process of coupling the driving circuit for driving the display panel that is determined to be a good product (after the panel test) or is repaired (when possible). For example, the power supply unit formed in the flexible printed circuit (FPC), other films, and/or the driver mounted on the substrate are coupled to the display panel.

The connection of the dummy wire that is floated in the cell cutting process (of the cell process S3) is then coupled to the ground electrode on the FPC or to the power source voltage supply unit for supplying the second power source voltage of the low potential (S5). The low potential power source voltage should be a lower voltage than the static electricity voltage applied through the floated dummy wire. Thus, static electricity that may flow in from the outside through the floated dummy wire may be removed through the ground electrode or the power source voltage supply unit for supplying the second power source voltage of the low potential.

If the process of the circuit connection for preventing static electricity is finished, a final test of the display panel is performed (S6). In the final test, if the display panel is determined to be a good product, the manufacturing of the display panel is completed (S7).

The drawings and detailed description described above represent exemplary embodiments of the present invention and are provided to better explain aspects and principles of the present invention. However, the scope of the present invention described above is not limited thereto. It will be appreciated by those skilled in the art that various modifications may be made and that other equivalent embodiments are available, all within the spirit and scope of the present invention. In addition, some of the components described in the specification may be omitted without deterioration of performance, or added in order to improve the performance, as would be apparent to those skilled in the art. Moreover, the sequence of steps of the methods described in the specification may be changed depending on a process environment or equipment as would be apparent to those skilled in the art. Accordingly, the spirit and scope of the present invention should be not limited by the above-mentioned exemplary embodiments, but by the appended claims and equivalents thereto.

Description of Some Symbols

| | |
|---|---|
| 1: display panel | 2: flexible printed circuit (FPC) |
| 3: chip on film (COF) | |
| 10: display unit | 20: driver |
| 30: power supply unit (PWS) | 40: ground electrode (GND) |
| 50: bypass capacitor (Cb) | |
| 11: glass substrate | 13: first power supply wire |
| 15-1, 15-2, 15-3: subpixels of the | 16: opposing substrate |
| display unit | |
| 17: second power supply layer | 19: contact hole |
| 100: second power supply wire | 200: dummy wire |
| 13a: first power supply wire connection | |
| 100a: second power supply wire | |
| connection | |

What is claimed is:

1. A display panel comprising:
a substrate;
a display unit on the substrate and comprising a plurality of pixels for displaying an image according to a video signal;
a power supply wire on the substrate, coupled to the plurality of pixels, and configured to transmit a driving voltage for driving the plurality of pixels; and
a dummy wire on the substrate, separated from the display unit and the power supply wire, and coupled to a ground electrode or a power supply unit for supplying the driving voltage.

2. The display panel of claim 1, wherein the dummy wire is a wire for testing a mother glass comprising a plurality of display panels comprising the display panel.

3. The display panel of claim 1, wherein
the dummy wire is coupled to a capacitor that is coupled to the ground electrode or the power supply unit, and
the capacitor comprises one terminal coupled to the dummy wire and another terminal coupled to the ground electrode or the power supply unit.

4. The display panel of claim 1, wherein the dummy wire is extended to a flexible printed circuit (FPC) comprising the ground electrode or the power supply.

5. The display panel of claim 4, wherein
the substrate is a flexible substrate, and
the dummy wire is extended to the FPC after passing through a film on which is mounted a driver for driving the display unit.

6. The display panel of claim 1, wherein the power supply wire comprises:
a first power supply wire for transmitting a first power source voltage; and
a second power supply wire for transmitting a second power source voltage that is lower than the first power source voltage.

7. The display panel of claim 1, wherein
the power supply unit comprises:
a first power source voltage supply unit for supplying a first power source voltage of a high potential; and
a second power source voltage supply unit for supplying a second power source voltage of a low potential that is lower than the first power source voltage, and
the dummy wire is coupled to the second power source voltage supply unit of the power supply unit.

8. The display panel of claim 1, wherein the dummy wire is located at edges of the substrate.

9. The display panel of claim 1, wherein the dummy wire is configured to transmit and remove static electricity through the ground electrode or the power supply unit coupled to the dummy wire.

10. A method of manufacturing a display panel, comprising:
manufacturing a mother glass comprising the display panel and a dummy wire for testing the mother glass;
testing the mother glass for defects using the dummy wire;
cutting the mother glass into a plurality of display panels comprising the display panel;
coupling a driving circuit for driving a plurality of pixels included in the display panel, the display panel being configured to display an image according to a video signal;
grounding the dummy wire included in the display panel or coupling the dummy wire to a power source voltage supply unit for supplying a power source voltage of a low potential; and
testing the display panel for defects after the grounding of the dummy wire or the coupling of the dummy wire to the power source voltage supply unit.

11. The method of claim 10, wherein the dummy wire is electrically floated after the cutting of the mother glass.

12. The method of claim 10, wherein the power source voltage of the low potential is a lower voltage than a voltage of static electricity flowing in to the dummy wire.

13. The method of claim 10, wherein the dummy wire is coupled to a capacitor that is coupled to a ground electrode or the power source voltage supply unit.

14. A display device comprising:
a substrate;
a display unit on the substrate and comprising a plurality of pixels for displaying an image according to a video signal;
a power supply wire on the substrate, coupled to the plurality of pixels, and configured to transmit a driving voltage for driving the plurality of pixels;
a dummy wire on the substrate, separated from the display unit and the power supply wire, and coupled to a ground electrode or a power supply unit for supplying the driving voltage; and
a flexible printed circuit (FPC) comprising the ground electrode or the power supply unit.

15. The display device of claim 14, wherein
the substrate is a flexible substrate, and
the display device further comprises a film between the substrate and the FPC on which is mounted a driving circuit for controlling operation of the display unit.

16. The display device of claim 14, wherein
the FPC further comprises a bypass capacitor for storing static electricity flowing in to the dummy wire, and
the bypass capacitor comprises one terminal coupled to the dummy wire and another terminal coupled to the ground electrode or the power supply unit.

17. The display device of claim 14, wherein
the power supply wire comprises:
a first power supply wire for transmitting a first power source voltage; and
a second power supply wire for transmitting a second power source voltage that is lower than the first power source voltage, and
the dummy wire is coupled to the second power supply wire.

18. The display device of claim 17, wherein
the power supply unit comprises a second power source voltage supply unit for supplying the second power source voltage to the second power supply wire, and
the dummy wire is coupled to the second power source voltage supply unit.

19. The display device of claim 14, wherein the dummy wire is a wire for testing a mother glass of a plurality of ones of the display unit, the power supply wire, and the dummy wire.

20. The display device of claim 14, wherein the dummy wire is located at edges of the substrate.
